(19) United States
(12) Patent Application Publication
(10) Pub. No.: US 2018/0047059 A1
(43) Pub. Date: Feb. 15, 2018

(54) TRIGGERING BEACONS THAT ARE USED IN POINT-OF-PURCHASE DISPLAYS AND OTHER IN-STORE DISPLAYS

(71) Applicant: WestRock Shared Services, LLC, Norcross, GA (US)

(72) Inventors: Phillip LAZO, Mt. Airy, MD (US); Thomas A. LOCKWOOD, Clemmons, NC (US); David B. RANKIN, Winston-Salem, NC (US)

(21) Appl. No.: 15/558,222

(22) PCT Filed: Mar. 29, 2016
(86) PCT No.: PCT/US16/24746

§ 371 Date: Sep. 14, 2017

Related U.S. Application Data
(60) Provisional application No. 62/139,922, filed on Mar. 30, 2015.

(51) Int. Cl. G06Q 30/02; H04W 4/00; H04W 4/20

(52) U.S. Cl. CPC G06Q 30/0268; H04W 4/206; H04W 4/008; G06Q 30/0261; G06Q 30/0251

(57) ABSTRACT

A system uses beacons with point-of-purchase displays and other in-store displays to direct customers to certain products of interest to the customer. The system determines which beacons should receive electrical power based on sensors within the displays.

### REFERENCE TO RELATED APPLICATION

This application claims the benefit of priority under 35 U.S.C. §119(e) of United States provisional application Ser. No. 62/139,922 filed on Mar. 30, 2015, which is hereby incorporated by reference in its entirety.

### TECHNICAL FIELD

The present disclosure relates generally to product displays and more particularly (although not necessarily exclusively) to a system for triggering beacons that are used in point-of-purchase displays and other in-store displays.

### BACKGROUND

Beacon technology can be used in retail stores to engage shoppers at a point of purchase. For example, relatively low-cost Bluetooth beacons can communicate with Bluetooth-enabled smart phones. Bluetooth beacons operate by sending out a beacon signal, through the Bluetooth wireless protocol, throughout an area. Current solutions involving beacon technology typically involve beacons that are constantly active, which may cause online content to be provided to a shopper regardless of the shopper's actual interest level in any given product in a coverage area of the beacon.

Improved systems and methods for activating beacons that are used in point-of-purchase displays and other in-store displays are desirable.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. This summary is a high-level overview of various aspects and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

Certain aspects and features of the present invention are directed to a retail display system that integrates beacon technology, such as a beacon using Bluetooth or another suitable short-range communication protocol, with retail displays in a store. In some aspects, beacons can transmit ultrasonic signals. Bluetooth beacon technology can be combined with on-shelf sensors (light, motion, others) in a retail shelf or other point-of-purchase display to provide contextual information to a mobile application executed on a mobile device used by a shopper in a retail store. The retail display system can be used to push or otherwise provide contextual product information, product contents, or other media content to a mobile device in response to a shopper manipulating a product package on a retail display shelf.

These illustrative aspects and features are mentioned not to limit or define the disclosure, but to provide examples to aid understanding of the concepts disclosed in this application. Other aspects, advantages, and features of the present disclosure will become apparent after review of the entire application.

### BRIEF DESCRIPTION OF THE DRAWINGS

FIG. 1 is a block diagram depicting an example of a system for selectively triggering beacons that are used in point-of-purchase displays and other in-store displays.

FIG. 2 is a diagram depicting another example of a system for selectively triggering beacons that are used in point-of-purchase displays and other in-store displays according to one aspect of the present disclosure.

FIG. 3 is a diagram of a pusher system that can be used for on-shelf sensing according to one aspect of the present disclosure.

FIG. 4 is a diagram depicting a pusher system causing a force to be applied to a coil of a rotary potentiometer for sensing purposes according to one aspect of the present disclosure.

FIG. 5 is a block diagram depicting an example of a computing system for processing inputs received using the sensor and outputting commands for activating a beacon according to one aspect of the present disclosure.

### DETAILED DESCRIPTION

A system for selectively triggering beacons that are used in point-of-purchase displays and other in-store displays is disclosed herein.

The subject matter of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

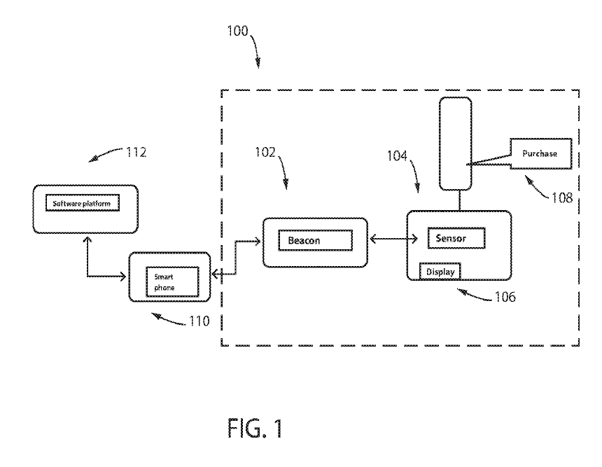

Referring now to the drawings, FIG. 1 is a block diagram depicting an example of a retail display system 100 for selectively triggering beacons 102 that are used in point-of-purchase displays and other in-store displays.

The retail display system 100 can include one or more sensors 104 and one or more beacons 102 that are integrated with or otherwise communicatively coupled to a retail display shelf 106. One or more of the sensors 104 can detect a movement of a package 108 on the shelf (e.g., removing a package 108 from a shelf, placing a package 108 on the shelf, etc.). For example, a light sensor 104 or electromagnetic sensor 104 near a product package 108 can be used to detect movement of the product package 108. A processing device included in or communicatively coupled to the beacon 102 can receive data from the sensor 104 that is indicative of a product package 108 being moved. In some aspects, the processing device can correlate the received data with a particular product (e.g., a specific product or brand that is located on a shelf near the sensor). The received data from the sensor 104 can trigger activation of the beacon 102.

Triggering activation of the beacon may include, as an example, turning on the beacon or otherwise causing power to be supplied to the beacon. In a first embodiment, a switch controlled by the processing device may be interposed between the beacon and its internal battery. Between the battery and the beacon's battery contacts may be interposed a pair of thin contacts wired to a relay controlled (triggered) by the processing device. In a second embodiment, the usual beacon battery may be replaced by a slightly thinner battery with an attached or integrated switch or relay (controlled/triggered by the processing device) where the attached or integrated switch or relay brings the combination battery-switch back to the thickness of the usual battery. In a third embodiment a magnetic switch may be interposed between the battery and the beacon contacts, and the magnetic switch triggered/actuated by an external electromagnet controlled by the processing device. In a fourth embodiment, the battery within the beacon may be replaced by a pair of contacts supplying power in lieu of the battery, with the supplied power being triggered/turned on or off by the processing device. This fourth embodiment removes the need for periodic replacement of the beacon battery. All of these embodiments involve the processing device triggering (turning on) the beacon when specific conditions have been met, such as the movement of a product on the shelf. The processing device may further determine how long the beacon should be active before it is turned off. For example the beacon may be turned on for a few seconds, such as 10 seconds or 30 seconds. The time for which a beacon is turned on may be determined by the processing device based on characteristics of the product(s) on the particular shelf.

A smart phone 110 or other mobile device used by a shopper in the retail store may execute a mobile application that is used to communicate with the retail display system 100. The mobile application can be programmed to receive unique beacon codes or other communications from a beacon 102. The beacon 102 can communicate using any suitable type of transmitted signal, such as (but not limited to) electronic or ultrasonic signals. If the mobile device 110 enters a coverage area of a beacon 102 and the shopper triggers the beacon 102 by manipulating a product package 108, the beacon 102 can transmit one or more messages to the mobile application (or cause the messages to be transmitted to the mobile application). The message or message may be the ID number of the beacon. The messages can direct the shopper to online content associated with the retail shopping experience. A coverage area of the beacon 102 can be, for example, 1-3 feet. However, the coverage area may be greater than 3 feet. The messages can be transmitted to the mobile application in a push manner (i.e., without requiring the shopper to perform a request for online content or other interaction using the mobile application). Different zones in a retail store can include different retail display systems, which can be used to automatically push online content to a shopper's mobile device 110 as the shopper enters various coverage zones throughout the store.

In some aspects, a server or cloud-based platform 112 in communication with a beacon 102 can be used for generating and/or communicating the online content to the mobile device 110. For example, a processing device included in or communicatively coupled to the beacon 102 can use Bluetooth or another short-range communication protocol to obtain an identifier of the mobile device 110. The processing device can provide the identifier to a server. The server can cause online content to be pushed to the mobile device 110.

The sensor 104 portion of the system depicted in FIG. 1 can be implemented in any suitable manner.

In some aspects, the sensor 104 can include an optical reader such as (but not limited to) spectrometer. The optical reader may detect movement, such as when an object is picked up or when a hand approaches the display shelf 106. The optical reader may be integrated into a display shelf 106. The optical reader may or may not be visible to a consumer. In an example where the optical reader is visible to the consumer, the display shelf 106 may be designed such that a consumer is instructed to place the package 108 in a certain area to initiate the push of information to the user's mobile device 110.

In additional or alternative aspects, the sensor 104 can detect a code discreetly hidden in the coloring of the package 108. For example, a particular color mix can be used that can be read by a color sensor 104 to indicate the presence of a package 108. Embedding a code in the color of the package 108 can allow transmitted information to be multi-bit, in that the sensor 104 is able to detect movement of the package 108 and determine what type of product is in the package 108. Embedding a code in the color of the package 108 can also allow a color code to blend in seamlessly to the package design for the package 108. Embedding a code in the color of the package 108 can also avoid detracting from branding information depicted on the package 108. Embedding a code in the color of the package 108 can also allow a color code to occupy a small footprint on the package 108 or be invisible to a consumer. A color code can be placed at any suitable location on the package 108. For example, placement of a color code may be determined by the shape of the package 108 and the design of the display shelf 106.

A color code sensor 104 may also be used for counting the number of items in a display, such as during inventory or to validate a planogram, i.e., to determine if the right product is on the display. For such an implementation, the display shelf 106 can include an array of sensors 104 usable for capturing or otherwise determining a number of products sitting on a display shelf 106. Additionally or alternatively, if the color code were on the top of the package 108, a camera above the shelf can be used to count the number of items in the display shelf 106.

In some aspects, the sensor 104 may operate by measuring the wavelength of visible light absorbed by a package 108. For example, the sensor 104 may shine a white light on the target. The sensor 104 may include three photodiodes, one having a red filter, one having a green filter, and one having a blue filter. The sensor 104 can digitize the strength of the returned color, and can run the result through an analog-to-digital conversion to return the RGB signature for that color. The logic in the display system can be calibrated in advance, using the color signatures of packages 108 that are intended for the display.

In some aspects, the color code can be invisible to the human eye. This allows for the use of color coding on a trademark protected package 108 design. The invisible color code can be achieved by using a color that is not in the visible spectrum, such as infrared (IR) or ultraviolet (UV). Painting the invisible color code over the package 108 would not obstruct the underlying colors of the package 108 and can allow the color code to be read by the sensor 104.

Other aspects allow for using a metallic code on the package 108. A metallic code can be read by an IR sensor. Such a metallic code can be printed as a 2-D patch antenna using conductive ink. The code can be printed on the outside or on the inside of the package 108. The position of the metallic code can be selected such that the metallic code does not detract from a trademark-protected package 108 design.

In some aspects, the metallic code can enable the automated computation of product inventory. For example, the retail display system 100 can include an electromagnetic transmitter and receiver. If the metallic code is irradiated with a signal, the antenna can absorb a maximum amount of energy. The receiver in the retail display system 100 can measure the energy present in the area. The logic in the retail display system 100 can determine how much energy was absorbed. The determined amount of absorbed energy can indicate how many packages 108 are present. The frequency of the absorbed signal can indicate the type of product. The logic in the retail display system 100 can be calibrated with the frequency signatures of the various products that can be shelved on the display.

In some aspects, one or more devices of the retail display system 100 can be powered via an energy harvesting unit. An energy harvesting unit can generate electrical current from other types of energy in the area in which one or more devices of the retail display system 100 are deployed. Examples of energy that can be harvested and used to generate electrical current include light, thermal energy, vibrations, etc.

In some aspects, a cell phone detector can be used in the retail display system 100 to detect whether a cell phone 110 is in the proximity of the display shelf 106. For example, if a cell phone 110 is determined to be near the display shelf 106, information about a product can be pushed to an application executed on the cell phone 110. Detecting the presence of a cell phone 110 can be accomplished by monitoring bands used by various cell phone 110 technologies. The logic in the retail display system 100 can be set to identify the carrier for the phone 110 based on the band used. Identifying the carrier can allow customized product information to be pushed to various users of mobile devices.

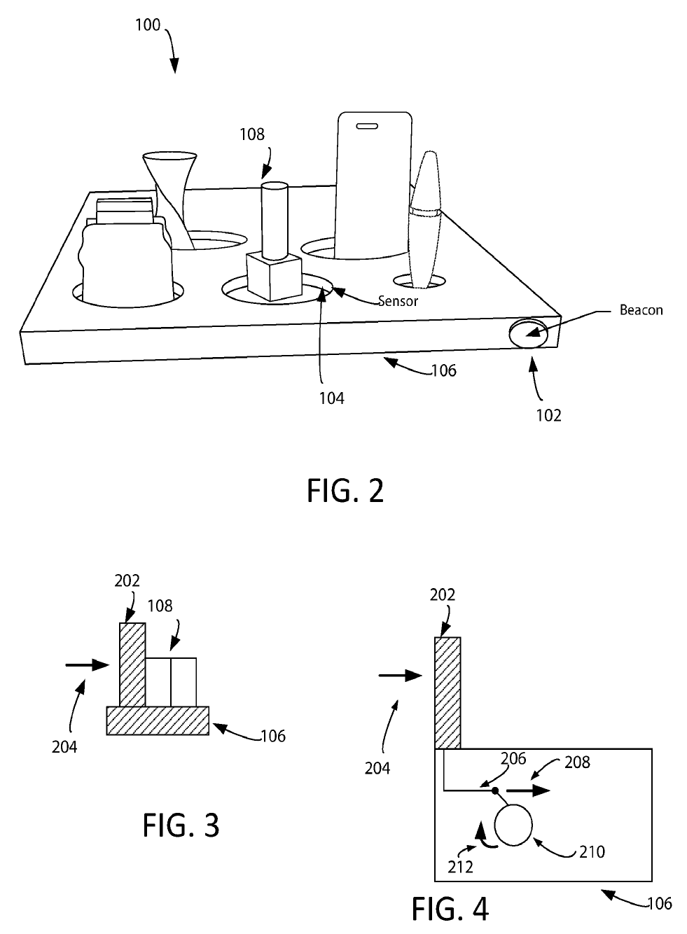

FIG. 2 is a diagram depicting an example of a retail display system 100. A sensor 104 can be positioned near a product 108 that is positioned on a shelf 106. In the example depicted in FIG. 2, the beacon 102 is attached or otherwise coupled to the shelf 106. An indication of the product 108 being moved can be detected using the sensor 108. The detection of this indicator by the sensor 108 can trigger the beacon 102. In some embodiments, triggering the beacon includes turning on the power to the beacon.

In some aspects, one or more of the retail display system 100 and the product packaging can include mechanical and/or design features that can optimize on-shelf sensing that is used to send contextual information to a user. For example, a pusher system can be used to align product packages 108 to a display sensor. A simplified example of such a pusher system is depicted in FIG. 3. A pusher 202 can be biased by a spring or other biasing mechanism. The spring or other biasing mechanism can exert a force 204 on the pusher 202 in the direction of the products 108. The pusher 202 can be coupled to a rotary potentiometer having a coil. For example, as depicted in FIG. 4, a connector 206 can be used to transfer force from the movement of the pusher 202 to a coil 210 of a rotary potentiometer in the shelf 106. For example, a force 204 can cause the pusher 202 to exert a force 208 on the connector 206, which in turn causes a force to be applied to the coil 210 and thereby causes the coil 210 to move in a rotating direction 212. The rotary potentiometer generates specific voltages to indicate the contents of the shelf, to facilitate with inventory control. The potentiometer can measure the position of the pusher 202 to determine the number of packages 108 that are on the shelf. This can be accomplished in a coil pusher by measuring the number of rotations in the coil 210.

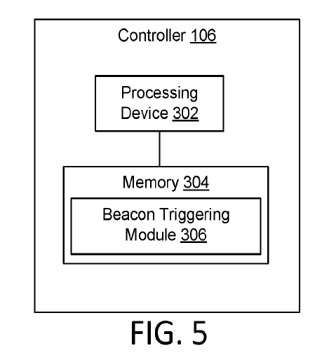

FIG. 5 is a block diagram depicting an example of a computing system for processing inputs received using the sensor 104 and outputting commands for activating a beacon 102 according to one aspect. The computing system can include a processing device 302 that includes or is communicatively coupled with a memory device 304. Examples of processing device 302 include a microprocessor, an application-specific integrated circuit (“ASIC”), a field-programmable gate array (“FPGA”), or other suitable processor. The processing device 302 may include one processor or any number of processors. The memory device 304 can be a non-transitory computer-readable medium for storing program instructions. The processing device 302 can execute the program instructions stored the memory device 304. The executable program instructions can include a beacon triggering module 306. The beacon triggering module 306 can perform one or more of the operations for selectively triggering a beacon 102 as described herein, including but not limited to turning on the power to a beacon.

The foregoing description of aspects and features of the disclosure, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of this disclosure. Aspects and features from each example disclosed can be combined with any other example. The illustrative examples described above are given to introduce the reader to the general subject matter discussed here and are not intended to limit the scope of the disclosed concepts.

1. A display system for use with a mobile device, the system comprising:
a first support structure to support one or more products including a first product;
a first computing system associated with the support structure;
a first sensor associated with the structure and in communication with the first computing system, the first sensor sensing at least one of the proximity or movement of the first product;
a first beacon emitting a signal identifying the first beacon; and
wherein the first sensor upon sensing the proximity or movement of the first product, sends a signal to the first computing system; and the first computing system determines to provide electrical power to the first beacon.

2. The display system of claim 1, wherein the determination whether to provide electrical power to the first beacon is based on the sensing of movement of the first product.

3. The display system of claim 1, wherein the determination whether to provide electrical power to the first beacon is based on the sensing of a lack of proximity of the first product.

4. The display system of claim 1, wherein providing electrical power to the first beacon comprising supplying the electrical power to the first beacon from a power source external to the first beacon.

5. The display system of claim 1, wherein providing electrical power to the first beacon comprising switching on a power source internal to the first beacon.

6. The display system of claim 1, wherein the determination to provide electrical power to the first beacon includes a determination of how long to provide the electrical power.

7. The display system of claim 1, wherein the first sensor is one of an optical sensor, magnetic sensor, capacitive sensor, vibration sensor, pressure sensor, and strain gauge.

8. The display system of claim 1, further comprising a mobile device, wherein the mobile device detects the signal from the first beacon and communicates with a software platform on the Internet to receive information about the first product.

9. The display system of claim 1, further comprising a second sensor and a second beacon, wherein the one or more products comprise a second product associated with the second sensor and the second beacon, wherein the second sensor upon sensing the proximity or movement of the second product, sends a signal to the first computing system; and the first computing system determines to provide electrical power to the second beacon.

10. The display system of claim 9, further comprising a mobile device, wherein the mobile device detects the signal from the second beacon and communicates with a software platform on the Internet to receive information about the second product.

11. The display system of claim 1, wherein the first support structure comprises at least one shelf.

12. The display system of claim 1, wherein the first beacon is a radio device transmitting a unique identifier.

13. The display system of claim 1, further comprising a sensor to detect the mobile device.

14. The display system of claim 13, wherein upon detection of the mobile device, the computing system determines to provide electrical power to the beacon.

15. The display system of claim 1, wherein the first support structure is a retail-ready display.

16. The display system of claim 1, wherein the first support structure is a point-of-purchase display.
